(19) United States
(12) Patent Application Publication
(10) Pub. No.: US 2026/0160494 A1
(43) Pub. Date: Jun. 11, 2026

(54) ELECTRODE DRYING APPARATUS AND ELECTRODE DRYING METHOD

(71) Applicant: SK On Co., Ltd., Seoul (KR)

(72) Inventors: Min Sik KIM, Daejeon (KR); Tae Hyun PARK, Daejeon (KR); Oh Hyuk KWON, Daejeon (KR); Sang Hwa LEE, Daejeon (KR)

(21) Appl. No.: 19/181,351

(22) Filed: Apr. 17, 2025

(30) Foreign Application Priority Data
Jun. 24, 2024 (KR) 10-2024-0081845

(51) Int. Cl. F26B 21/35; F26B 3/04; H01M 4/04

(52) U.S. Cl. CPC F26B 21/35; F26B 3/04; H01M 4/0404

(57) ABSTRACT

Proposed are an electrode drying apparatus and an electrode drying method. The method includes a bypass duct opening step of controlling a bypass damper connected to a bypass duct so that the bypass duct connecting a supply duct and an exhaust duct of a dryer chamber is opened before an electrode re-enters the dryer chamber, a first supply amount control step of controlling a heat transfer medium supplier so that an amount of a heat transfer medium supplied to a heater that heats a fluid in the supply duct becomes a first set amount before the electrode re-enters the dryer chamber, and a second supply amount control step of controlling the heat transfer medium supplier to fix the amount of the heat transfer medium supplied to the heater to a reference supply amount at a point when the electrode re-enters the dryer chamber.

### CROSS REFERENCE TO RELATED APPLICATION

The present application claims priority to Korean Patent Application No. 10-2024-0081845, filed June 24, 2024, the entire contents of which is incorporated herein for all purposes by this reference.

### TECHNICAL FIELD

The present disclosure relates to an electrode drying apparatus and an electrode drying method.

### BACKGROUND

Secondary batteries, which can be charged and discharged multiple times, are used in electric vehicles, energy storage systems (ESS), smartphones, and various other devices. Electrodes, separators, and electrolytes are key components of secondary batteries. In electrode production, drying devices are used. The drying devices can dry electrodes in a state where the active material is coated on the current collector. The drying devices performs drying as the electrodes pass through while maintaining the internal temperature using hot air.

### SUMMARY

According to an aspect of the present disclosure, provided is an electrode drying apparatus and an electrode drying method for controlling internal temperature to prevent overdrying of electrodes.

An electrode drying apparatus and an electrode drying method according to an aspect of the present disclosure can be applied to a process for manufacturing batteries widely used in green technology fields such as electric vehicles, battery charging stations, and solar and wind power generation using batteries.

An electrode drying apparatus and an electrode drying method according to an aspect of the present disclosure can be applied to a process for manufacturing batteries used in eco-friendly electric vehicles, hybrid vehicles, etc., to prevent climate change by suppressing air pollution and greenhouse gas emissions.

An electrode drying method according to an embodiment of the present disclosure is to regulate the temperature of a dryer chamber when an electrode is temporarily stopped from entering the dryer chamber and the electrode re-enters the dryer chamber after a certain period of time has elapsed. The method may include: a bypass duct opening step of controlling a bypass damper connected to a bypass duct so that the bypass duct connecting a supply duct and an exhaust duct of the dryer chamber is opened before the electrode re-enters the dryer chamber; a first supply amount control step of controlling a heat transfer medium supplier so that an amount of a heat transfer medium supplied to a heater that heats a fluid in the supply duct becomes a first set amount before the electrode re-enters the dryer chamber; and a second supply amount control step of controlling the heat transfer medium supplier to fix the amount of the heat transfer medium supplied to the heater to a reference supply amount at a point when the electrode re-enters the dryer chamber.

The electrode drying method according to an embodiment may further include: a bypass duct closing step of controlling the bypass damper so that the bypass duct is closed when the temperature of the dryer chamber reaches a drying stable temperature; and a third supply amount control step of controlling the heat transfer medium supplier by using feedback control to control the amount of the heat transfer medium supplied to the heater on a basis of temperature of the exhaust duct when the temperature of the dryer chamber reaches the drying stable temperature.

The electrode drying method according to an embodiment may further include a pause mode step, prior to the bypass duct opening step, of performing a pause mode for maintaining an internal temperature of the dryer chamber at a set temperature when the electrode stops entering the dryer chamber.

According to an embodiment, the pause mode may be a mode in which temperature of the exhaust duct is maintained higher than the temperature of the exhaust duct in a drying stable state, and temperature of the supply duct is maintained lower than the temperature of the supply duct in the drying stable state.

According to an embodiment, the bypass duct opening step and the first supply amount control step may be performed simultaneously.

According to an embodiment, the reference supply amount of the second supply amount control step may be the amount of the heat transfer medium supplied to the heater in a drying stable state.

According to an embodiment, an amount of a fluid supplied to the dryer chamber through the supply duct and an amount of a fluid discharged from the dryer chamber through the exhaust duct may be kept constant.

An electrode drying apparatus according to an embodiment of the present disclosure may include: a dryer chamber through which an electrode passes and is dried; a supply duct configured to supply a fluid to the dryer chamber; an exhaust duct configured to discharge a fluid from the dryer chamber; a bypass duct configured to connect the supply duct and the exhaust duct; a bypass damper configured to operate to open or close the bypass duct; a heater configured to heat the fluid supplied to the dryer chamber through the supply duct; a heat transfer medium supplier configured to supply a heat transfer medium to the heater; and a controller configured to control the bypass damper and the heat transfer medium supplier.

The controller may: control, before the electrode re-enters the dryer chamber in a case where the electrode is temporarily stopped from entering the dryer chamber and enters the dryer chamber again after a certain period of time has elapsed, the bypass damper connected to the bypass duct so that the bypass duct connecting the supply duct and the exhaust duct of the dryer chamber is opened; control the heat transfer medium supplier so that an amount of the heat transfer medium supplied to the heater that heats the fluid in the supply duct becomes a first set amount; and control, at a point when the electrode re-enters the dryer chamber, the heat transfer medium supplier to fix the amount of the heat transfer medium supplied to the heater to a reference supply amount.

The electrode drying apparatus according to an embodiment may further include: a first temperature sensor connected to the supply duct to measure temperature of the fluid supplied from the supply duct to the dryer chamber; and a second temperature sensor connected to the exhaust duct to measure temperature of the fluid discharged from the dryer chamber to the exhaust duct, wherein the controller may control, when temperature of the dryer chamber reaches a drying stable temperature on a basis of measurement values of the first temperature sensor and the second temperature sensor, the bypass damper so that the bypass duct is closed, and control the heat transfer medium supplier by using feedback control that controls the amount of the heat transfer medium supplied to the heater on a basis of temperature of the exhaust duct.

According to an embodiment, the controller may further perform a pause mode to maintain an internal temperature of the dryer chamber at a set temperature until the bypass duct is opened when the electrode stops entering the dryer chamber.

According to an embodiment, the pause mode may be a mode in which temperature of the exhaust duct is maintained higher than the temperature of the exhaust duct in a drying stable state, and temperature of the supply duct is maintained lower than the temperature of the supply duct in the drying stable state.

According to an embodiment, the controller may simultaneously perform an operation of controlling the bypass damper connected to the bypass duct so that the bypass duct connecting the supply duct and the exhaust duct of the dryer chamber is opened, and an operation of controlling the heat transfer medium supplier so that the amount of heat transfer medium supplied to the heater that heats the fluid in the supply duct becomes the first set amount.

According to an embodiment, the reference supply amount may be the amount of the heat transfer medium supplied to the heater in a drying stable state.

According to an embodiment, the electrode drying apparatus may further include an air supplier configured to supply a fluid through the supply duct, wherein the controller may control the air supplier to keep an amount of the fluid supplied to the dryer chamber through the supply duct and an amount of the fluid discharged from the dryer chamber through the exhaust duct constant.

The features and advantages of the present disclosure will become more apparent from the following detailed description based on the accompanying drawings.

Prior to this, terms or words used in this specification and claims should not be construed in their usual, dictionary meaning, and should be interpreted with meaning and concept consistent with the technical idea of the present disclosure on the basis of the principle that the inventor can define terminology appropriately to explain his or her invention in the best way possible.

According to an embodiment of the present disclosure, by controlling the temperature inside an electrode drying device, it is possible to prevent defects due to overdrying of an electrode.

According to an embodiment of the present disclosure, it is possible to effectively prevent overdrying in the initial stage of electrode drying.

### BRIEF DESCRIPTION OF THE DRAWINGS

FIG. 1 is a view showing an electrode drying apparatus according to an embodiment.

FIG. 2 is a view showing an environment in which an electrode drying apparatus according to an embodiment controls temperature.

FIG. 3 is a view showing the flow of fluid when a bypass duct is opened according to an embodiment.

FIG. 4 is a view showing a change in supply air temperature according to control of the supply amount of a heat transfer medium according to an embodiment.

FIG. 5 is a view showing the temperature change of a supply duct when the supply amount of a heat transfer medium is fixed and when the supply amount of the heat transfer medium is feedback controlled, with a bypass duct open according to an embodiment.

FIG. 6 is a view showing the temperature in pause mode according to an embodiment.

FIG. 7 is a flowchart showing an electrode drying method according to an embodiment.

FIG. 8 is a view showing the temperature change in a dryer chamber according to an embodiment.

### DETAILED DESCRIPTION

Hereinafter, the present disclosure will be described in detail (with reference to the attached drawings). However, this is only exemplary and the present disclosure is not limited to the specific embodiments described as exemplary.

Hereinafter, an embodiment of the present disclosure will be described in detail with reference to the attached drawings.

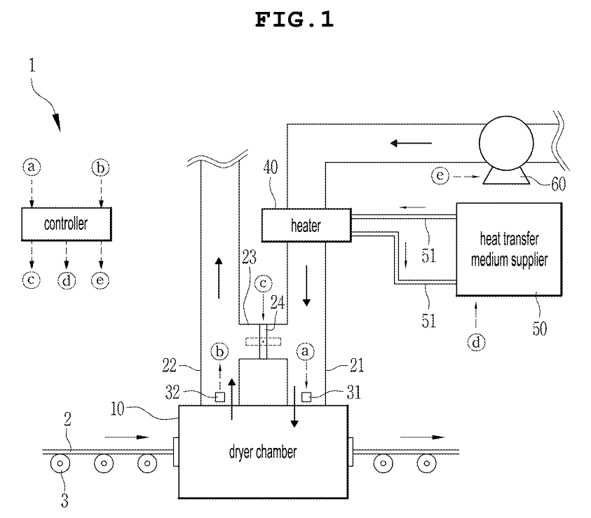

FIG. 1 is a view showing an electrode drying apparatus 1 according to an embodiment.

The electrode drying apparatus 1 according to an embodiment is equipment used in the production of an electrode 2. The electrode 2 is formed by coating an active material on a current collector by a coater 4, and then the active material is dried as the electrode 2 passes through the electrode drying apparatus 1. When the electrode drying apparatus 1 overdries the electrode 2, cracks may occur in the electrode 2. The electrode drying apparatus 1 according to an embodiment controls the drying temperature so that the electrode 2 is not overdried.

The electrode drying apparatus 1 according to an embodiment may include: a dryer chamber 10 through which the electrode 2 passes and is dried; a supply duct 21 for supplying fluid to the dryer chamber 10; an exhaust duct 22 for discharging the fluid from the dryer chamber 10; a bypass duct 23 connecting the supply duct 21 and the exhaust duct 22; a bypass damper 24 operating to open or close the bypass duct 23; a heater 40 for heating the fluid supplied to the dryer chamber 10 through the supply duct 21; a heat transfer medium supplier 50 that supplies a heat transfer medium to the heater 40; and a controller 70 that controls the bypass damper 24 and the heat transfer medium supplier 50.

The electrode drying apparatus 1 according to an embodiment may further include: a first temperature sensor connected to the supply duct 21 to measure the temperature of the fluid supplied from the supply duct 21 to the dryer chamber 10; and a second temperature sensor connected to the exhaust duct 22 to measure the temperature of the fluid discharged from the dryer chamber 10 to the exhaust duct 22.

The dryer chamber 10 is a space where drying takes place as the electrode 2 passes through thereinside. The electrode 2 enters the dryer chamber 10 through an inlet, and the dried electrode 2 exits through an outlet. The dryer chamber 10 may maintain the internal temperature by receiving a high-temperature fluid. The fluid may include air, nitrogen, etc.

A guide roller 3 is a roller that transports the electrode 2 to the dryer chamber 10. The guide roller 3 may transport the dried electrode 2 exited from the dryer chamber 10. The guide roller 3 may also transport the current collector to the coater 4.

The supply duct 21 may be connected to the dryer chamber 10. The supply duct 21 is a passage that supplies high-temperature fluid to the dryer chamber 10. The exhaust duct 22 may be connected to the dryer chamber 10. The exhaust duct 22 is a passage that discharges fluid used for drying the electrode 2 from the dryer chamber 10. The bypass duct 23 is a passage that connects the supply duct 21 and the exhaust duct 22.

The bypass damper 24 may be provided in the bypass duct 23. The bypass damper 24 may be located in the center, one end, or the other end of the bypass duct 23. The bypass damper 24 may open and close the bypass duct 23. The bypass damper 24 may adjust the degree of opening. The opening or closing of the bypass damper 24 may be controlled by the controller 70.

The first temperature sensor 31 may be connected to the supply duct 21. The first temperature sensor 31 may measure the temperature of the supply duct 21 and provide the measured temperature to the controller 70. The temperature of the supply duct 21 is the temperature of the fluid supplied to the dryer chamber 10 from the supply duct 21.

The second temperature sensor 32 may be connected to the exhaust duct 22. The second temperature sensor 32 may measure the temperature of the exhaust duct 22 and provide the measured temperature to the controller 70. The temperature of the exhaust duct 22 is the temperature of the fluid discharged from the dryer chamber 10 to the exhaust duct 22.

The controller 70 may measure the temperature of the dryer chamber 10 by means of the second temperature sensor 32. This is because the temperature of the fluid discharged through the exhaust duct 22 corresponds to the temperature of the dryer chamber 10.

The heater 40 may heat the fluid supplied to the supply duct 21. The heater 40 may receive heat from a heat transfer medium and heat the fluid. The heater 40 may be a heat exchanger that transfers heat from the heat transfer medium to the fluid.

The heat transfer medium is a medium that supplies heat to heat the fluid. The heat transfer medium may include oil, steam, etc. that can transfer high heat. The heat transfer medium may be supplied to the heater 40 by the heat transfer medium supplier 50.

The heat transfer medium supplier 50 may heat the heat transfer medium and supply the heat transfer medium to the heater 40. The heat transfer medium supplier 50 may control the supply amount of the heat transfer medium supplied to the heater 40. The heat transfer medium supplier 50 may adjust the supply amount of the heat transfer medium under the control of the controller 70.

A heat transfer medium pipe 51 is a pipe through which the heat transfer medium flows. The heat transfer medium pipe 51 may connect the heater 40 and the heat transfer medium supplier 50.

An air supplier 60 may supply fluid to the supply duct 21. The air supplier 60 may include a valve, a blower, etc.

The controller 70 may receive a measurement value ⓐ of the first temperature sensor 31 and a measurement value ⓑ of the second temperature sensor 32. The controller 70 may provide a control signal ⓒ to the bypass damper 24, a control signal ⓓ to the heat transfer medium supplier 50, and a control signal ⓔ to the air supplier 60.

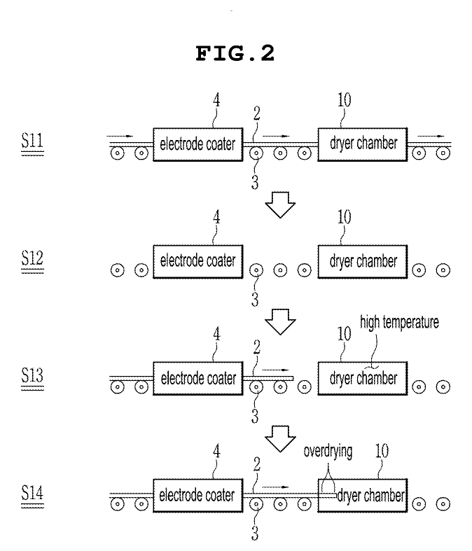

FIG. 2 is a view showing an environment in which the electrode drying apparatus 1 according to an embodiment controls temperature.

The electrode drying apparatus 1 may be used to dry the electrode 2 on which the active material is coated on the current collector. The electrode coater 4 is a device that coats an active material on a current collector. The electrode 2 output from the electrode coater 4 may be transferred to the dryer chamber 10 of the electrode drying apparatus 1. S11 of FIG. 2 represents a step of continuously drying the electrode 2. In the step of continuously drying the electrode 2, the electrode 2 may be continuously input into the dryer chamber 10, and dried and output. In the step of continuously drying the electrode 2, the temperature of the dryer chamber 10 is maintained constant, which may be called a drying stable state. The temperature of the dryer chamber 10 in the dry stable state may be called a drying stable temperature. The drying stable temperature is that the temperature of the supply duct 21 is maintained constant, and the temperature of the exhaust duct 22 is maintained constant.

S12 of FIG. 2 represents a step in which continuous drying of the electrode 2 is temporarily stopped. The electrode 2 may not be supplied to the dryer chamber 10 temporarily due to changing the roll on which the current collector is wound, the current collector or the electrode 2 being broken, or other various reasons. The point in time when the electrode 2 is no longer supplied to the dryer chamber 10 may be referred to as the drying stop point.

S13 of FIG. 2 represents a step in which the electrode 2 is transferred to the dryer chamber 10 to enter the dryer chamber 10. In this case, the electrode 2 may be transferred toward the dryer chamber 10 at a set moving speed and may enter the dryer chamber 10 after a set time. The position of the electrode 2 shown in S13 of FIG. 2 may change.

S14 of FIG. 2 represents a step in which the electrode 2 re-enters the dryer chamber 10 and part of the electrode 2 begins to dry. There is a possibility that part of the electrode 2 initially entered the dryer chamber 10 may be overdried.

In the case where the electrode 2 is continuously dried in the drying stable state like S11, and then the electrode 2 temporarily stops entering the dryer chamber 10 like S12, if a high temperature fluid is continuously supplied to the dryer chamber 10, the temperature inside the dryer chamber 10 may rise higher than the temperature of the dryer chamber 10 in the drying stable state. When the electrode 2 enters the dryer chamber 10 that is at a higher temperature than the temperature of the dryer chamber 10 in the drying stable state, an overdried area may occur at the initial stage of entering the dryer chamber 10 as in S14.

The electrode drying apparatus 1 and an electrode drying method according to an embodiment may prevent the occurrence of the overdried area at the initial stage when the electrode 2 enters the dryer chamber 10 by adjusting the temperature of the dryer chamber 10 when the electrode 2 is temporarily stopped from entering the dryer chamber 10 and enters the dryer chamber 10 again after a certain period of time has elapsed.

To prevent overdrying at the initial stage of electrode drying restart, the controller 70 may control, before the electrode 2 re-enters the dryer chamber 10 in the case where the electrode 2 is temporarily stopped from entering the dryer chamber 10 and enters the dryer chamber 10 again after a certain period of time has elapsed, the bypass damper 24 connected to the bypass duct 23 so that the bypass duct 23 connecting the supply duct 21 and the exhaust duct 22 of the dryer chamber 10 is opened, may control the heat transfer medium supplier 50 so that the amount of heat transfer medium supplied to the heater 40 that heats the fluid in the supply duct 21 becomes a first set amount, and may control, at the point when the electrode 2 re-enters the dryer chamber 10, the heat transfer medium supplier 50 to fix the supply amount of the heat transfer medium supplied to the heater 40 to a reference supply amount.

The controller 70 may control to lower the temperature of the dryer chamber 10 in advance before restarting the drying. The controller may control the bypass damper 24 to open the bypass duct 23 before the electrode 2 re-enters the dryer chamber 10. That is, at the time shown in S13 of FIG. 2, the controller 70 may perform control to lower the temperature of the dryer chamber 10. First, the temperature change in the dryer chamber 10 and the change in the amount of heat transfer medium supplied when the bypass duct 23 is opened will be described.

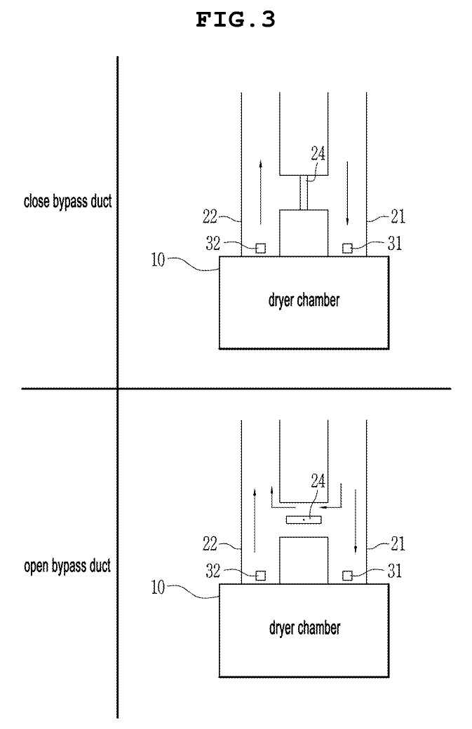

FIG. 3 is a view showing the flow of fluid when the bypass duct 23 is opened according to an embodiment.

With the bypass damper 24 closed, all of the fluid flowing through the supply duct 21 may be supplied to the dryer chamber 10. In addition, the exhaust duct 22 may discharge all of the fluid discharged from the dryer chamber 10.

When the bypass duct 23 is opened, the fluid supplied to the dryer chamber 10 from the supply duct 21 and the fluid discharged from the dryer chamber 10 to the exhaust duct 22 may be mixed through the bypass duct 23. To put it differently, a portion of the fluid supplied from the supply duct 21 to the dryer chamber 10 may enter the exhaust duct 22 through the bypass duct 23, and a portion of the fluid discharged from the dryer chamber 10 to the exhaust duct 22 may enter the supply duct 21 through the bypass duct 23.

When the bypass duct 23 is opened, measurement values of the first temperature sensor 31 and the second temperature sensor 32 may change. When the bypass duct 23 is opened, the fluid supplied by the supply duct 21 is discharged to the exhaust duct 22 through the bypass duct 23, and thus the measurement values of the first temperature sensor 31 and the second temperature sensor 32 may decrease. When the bypass duct 23 is opened, only a portion of the fluid flowing through the supply duct 21 is supplied to the dryer chamber 10, and thus the temperature of the dryer chamber 10 may decrease.

The controller 70 may control the bypass damper 24 connected to the bypass duct 23 so that the bypass duct 23 connecting the supply duct 21 and the exhaust duct 22 of the dryer chamber 10 is opened before the electrode 2 re-enters the dryer chamber 10 in the case where the electrode 2 is temporarily stopped from entering the dryer chamber 10 and enters the dryer chamber 10 again after a certain period of time has elapsed.

When the controller 70 opens the bypass duct 23 before the electrode 2 re-enters the dryer chamber 10, the temperature of the dryer chamber 10 may decrease. Therefore, the temperature of the dryer chamber 10 may be in a decreased state at the time the electrode 2 re-enters the dryer chamber 10.

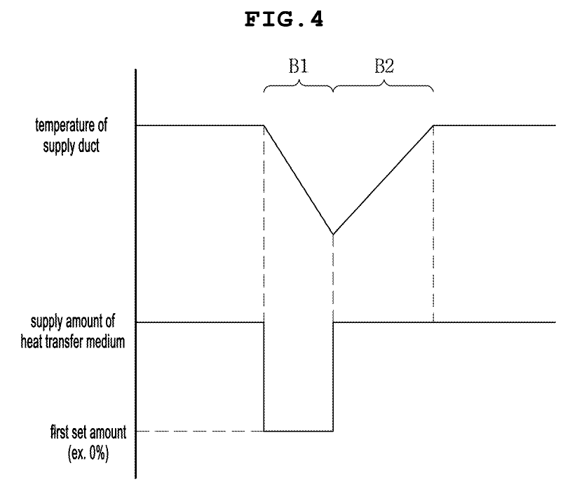

FIG. 4 is a view showing a change in supply air temperature according to control of the supply amount of a heat transfer medium according to an embodiment.

The controller 70 may control the heat transfer medium supplier 50 so that the amount of heat transfer medium supplied to the heater 40 that heats the fluid in the supply duct 21 becomes the first set amount before the electrode 2 re-enters the dryer chamber 10 in the case where the electrode 2 is temporarily stopped from entering the dryer chamber 10 and enters the dryer chamber 10 again after a certain period of time has elapsed.

The first set amount may be a value lower than the supply amount of the heat transfer medium at the drying stable temperature. The first set amount may be determined to be a value much smaller than the supply amount of the heat transfer medium at the drying stable temperature. For example, the first set amount may be 0%. The first setting amount being 0% means that the heat transfer medium supplier 50 does not supply heat transfer medium to the heater 40. When the amount of heat transfer medium supplied to the heater 40 reaches the first set amount before the electrode 2 re-enters the dryer chamber 10, the temperature of the fluid supplied to the dryer chamber 10 through the supply duct 21 may drop rapidly, thereby lowering the temperature of the dryer chamber 10. Therefore, the temperature of the dryer chamber 10 may be lowered at the time when the electrode 2 re-enters the dryer chamber 10.

Section B1 of FIG. 4 is a section in which the supply amount of the heat transfer medium is maintained at the first set amount. It can be confirmed in the drawing that when the supply amount of the heat transfer medium is maintained at the first set amount, the temperature of the supply duct 21 decreases.

Section B2 of FIG. 4 is a section in which the supply amount of the heat transfer medium is restored to a set value and the temperature of the supply duct 21 is restored to a set temperature. It can be confirmed in the drawing that when the supply amount of the heat transfer medium is restored to the set value rather than the first set amount, the temperature of the supply duct 21 gradually increases and restores to the set temperature.

The controller 70 may simultaneously perform an operation of controlling the bypass damper 24 connected to the bypass duct 23 so that the bypass duct 23 connecting the supply duct 21 and the exhaust duct 22 of the dryer chamber 10 is opened, and an operation of controlling the heat transfer medium supplier 50 so that the amount of heat transfer medium supplied to the heater 40 that heats the fluid in the supply duct 21 becomes the first set amount. Accordingly, as the effect of lowering temperature of the dryer chamber 10 by opening the bypass duct 23 and the effect of lowering temperature of the dryer chamber 10 by controlling the supply amount of the heat transfer medium to the first set amount combine, the temperature of the dryer chamber 10 may decrease more quickly. In addition, the temperature of the fluid discharged from the dryer chamber 10 through the exhaust duct 22 may also decrease more quickly.

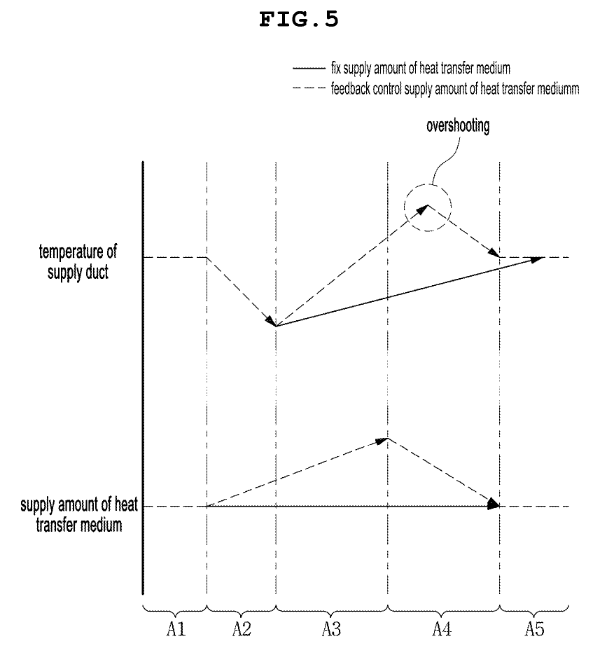

FIG. 5 is a view showing the temperature change of the supply duct 21 when the supply amount of the heat transfer medium is fixed and when the supply amount of the heat transfer medium is feedback controlled, with the bypass duct 23 open according to an embodiment.

When the supply amount of heat transfer medium is feedback controlled, the amount of heat transfer medium supplied may be controlled on the basis of the measurement value of the second temperature sensor 32 connected to the exhaust duct 22. This is because the temperature of the fluid discharged through the exhaust duct 22 can be considered the temperature of the dryer chamber 10. The temperature of the exhaust duct 22 may be measured by the second temperature sensor 32 and provided to the controller 70. The feedback control may include proportional-integral-derivative (PID) control performed by the controller 70. The feedback control may be used to increase the amount of heat transfer medium supplied to maintain the temperature of the dryer chamber 10 at a set temperature when the temperature of the exhaust duct 22 decreases, thereby raising the temperature of the supply duct 21, and to reduce the amount of heat transfer medium supplied to maintain the temperature of the dryer chamber 10 at a set temperature when the temperature of the exhaust duct 22 increases, thereby lowering the temperature of the supply duct 21.

Section A1 of FIG. 5 is a state in which the temperature of the dryer chamber 10 is maintained at a set temperature, and the bypass duct 23 is closed. Therefore, it can be confirmed that the amount of heat transfer medium supplied is constant and the temperature of the supply duct 21 is also constant.

Section A2 of FIG. 5 is a state in which the bypass duct 23 is opened. When the bypass duct 23 is opened, the temperature of the supply duct 21 and the temperature of the exhaust duct 22 both decrease. Therefore, it can be confirmed that the supply air temperature decreases in section A2 of FIG. 5, and that the amount of heat transfer medium supplied under feedback control increases.

Section A3 of FIG. 5 is a state in which the bypass duct 23 is closed again. When the bypass duct 23 is closed again, the temperature of the supply duct 21 and the temperature of the exhaust duct 22 may change independently.

In the case of feedback control, the amount of heat transfer medium supplied continues to increase. This is because even if the bypass duct 23 is closed, the temperature of the exhaust duct 22 does not immediately rise to a set temperature. Since the amount of heat transfer medium supplied increases, the temperature of the supply duct 21 may continue to rise.

When the supply amount of the heat transfer medium is fixed, the temperature of the supply duct 21 gradually increases. Since the supply amount of the heat transfer medium is fixed regardless of the temperature of the exhaust duct 22, the supply air temperature may gradually increase to a set temperature.

Section A4 of FIG. 5 is the section from the time when the temperature of the exhaust duct 22 reaches the drying stable temperature until the temperature of the supply duct 21 reaches the drying stable temperature.

In the case of feedback control, the amount of heat transfer medium supplied increases, causing overshooting in which the supply air temperature excessively increases, and accordingly, the temperature of the dryer chamber 10 rises above the drying stable temperature, and thus the amount of heat transfer medium supplied is lowered by feedback control. If this process is repeated, hunting may occur in which the temperature of the dryer chamber 10 rises above the drying stable temperature and then falls.

On the other hand, when supply amount of the heat transfer medium is fixed, the temperature of the supply duct 21 gradually increases and may finally reach the drying stable temperature. Since the temperature increase of the supply duct 21 occurs relatively slowly, the time at which the temperature of the exhaust duct 22 reaches the drying stable temperature may be relatively late, but hunting may not occur.

Section A5 of FIG. 5 is the where the temperature of the exhaust duct and the temperature of the supply duct 21 reach the drying stable temperature. In the case of feedback control, hunting may occur, but hunting may be prevented if the supply amount of the heat transfer medium is fixed.

According to an embodiment, at the point when the electrode 2 enters the dryer chamber 10 again, the controller 70 may control the heat transfer medium supplier 50 to fix the supply amount of the heat transfer medium supplied to the heater 40 to a reference supply amount. At this time, the reference supply amount may be the supply amount of the heat transfer medium supplied to the heater 40 in the drying stable state.

At the point when the electrode 2 re-enters the dryer chamber 10, the bypass duct 23 is open, and the supply amount of the heat transfer medium may be changed from 0 to the reference supply amount. When the supply amount of the heat transfer medium becomes the reference supply amount, the temperature of the supply duct 21 may gradually increase, similar to the temperature of the supply duct 21 in sections A3 and A4 of FIG. 5. As explained with reference to FIG. 5, since the supply amount of the heat transfer medium is fixed, overshooting of the supply air temperature does not occur and hunting may not occur. Since the supply amount of the heat transfer medium is fixed to the supply amount of the heat transfer medium supplied to the heater 40 in the drying stable state, the supply air temperature does not increase more than the supply air temperature in the drying stable state. Therefore, the temperature of the dryer chamber 10 may gradually converge to the drying stable temperature.

The controller 70 according to an embodiment may control, on the basis of the measurement values of the first temperature sensor and the second temperature sensor, the bypass damper 24 to close the bypass duct 23 when the temperature of the dryer chamber 10 reaches the drying stable temperature and may control the heat transfer medium supplier 50 in a feedback control manner that controls the amount of heat transfer medium supplied to the heater 40 on the basis of the temperature of the exhaust duct 22.

The controller 70 may control the bypass damper 24 to close the bypass duct 23 when the temperature of the dryer chamber 10 reaches the drying stable temperature. Once the bypass duct 23 is closed, the temperature of the supply duct 21 and the temperature of the exhaust duct 22 may change independently. In addition, since the temperature of the dryer chamber 10 has reached the drying stable temperature, hunting may not occur even if the supply amount of the heat transfer medium is controlled in a feedback manner. Therefore, when the temperature of the dryer chamber 10 reaches the drying stable temperature, the controller 70 may control the heat transfer medium supplier 50 in a feedback control manner that controls the amount of heat transfer medium supplied to the heater 40 on the basis of the temperature of the exhaust duct 22.

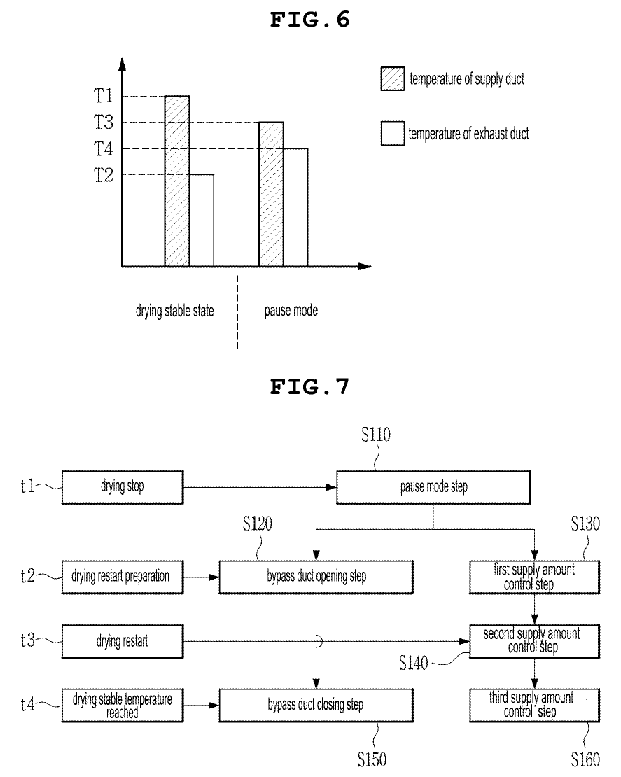

FIG. 6 is a view showing the temperature in pause mode according to an embodiment.

The controller 70 may further perform a pause mode to maintain the internal temperature of the dryer chamber 10 at a set temperature until the bypass duct 23 is opened when the electrode 2 stops entering the dryer chamber 10.

The pause mode may be a mode in which the temperature T4 of the exhaust duct 22 is maintained higher than the temperature T2 of the exhaust duct 22 in the drying stable state, and the temperature T3 of the supply duct 21 is maintained lower than the temperature T1 of the supply duct 21 in the drying stable state.

In the drying stable state, the temperature difference (T1-T2) between the supply duct 21 and the exhaust duct 22 is greater than the temperature difference (T3-T4) between the supply duct 21 and the exhaust duct 22 in the pause mode. In the drying stable state, heat is used while drying the electrode 2, and thus the temperature difference (T1-T2) between the supply duct 21 and the exhaust duct 22 is relatively large. In the pause mode, since drying is temporarily stopped, no heat is consumed in drying the electrode 2, and thus the temperature difference (T3-T4) between the supply duct 21 and the exhaust duct 22 is relatively small.

In cases where the supply duct 21 continuously supplies fluid to the dryer chamber 10 in S12 and S13 of FIG. 2, the temperature of the dryer chamber 10 may become high. In such cases, it takes a lot of time to lower the temperature to the drying stable temperature, and energy used to raise the temperature of the dryer chamber 10 is wasted.

In cases where the supply duct 21 stops supplying fluid to the dryer chamber 10 in S12 and S13 of FIG. 2, the temperature of the dryer chamber 10 may become low. In such cases, it takes a lot of time to raise the temperature to the drying stable temperature, and energy used to raise the temperature of the dryer chamber 10 is relatively large.

According to an embodiment, the controller 70 may maintain the temperature of the exhaust duct 22 in the pause mode higher than the temperature of the exhaust duct 22 in the drying stable state, and for this purpose, may maintain the temperature of the supply duct 21 lower than the temperature of the supply duct 21 in the drying stable state. This is economical because the amount of heat transfer medium supplied to maintain the temperature of the supply duct 21 in the pause mode lower than the temperature of the supply duct 21 in the drying stable state is smaller than the amount of heat transfer medium supplied in the drying stable state. In addition, since the controller 70 controls the supply amount of the heat transfer medium using feedback control in the pause mode, the set temperature range may neither be exceeded nor fallen below. Furthermore, the drying stable state may be entered quickly because in order to re-enter the drying stable temperature, lowering the temperature of the dryer chamber 10 can be done quickly, but raising the temperature of the dryer chamber 10 requires a relatively long time.

The controller 70 may start the pause mode immediately when drying is stopped, maintain the pause mode state, and when the time to restart drying is determined, control the bypass damper 24 and control the supply amount of heat transfer medium to control the temperature of the dryer chamber 10.

Referring back to FIG. 1, the electrode drying apparatus 1 according to an embodiment may further include the air supplier that supplies fluid through the supply duct 21. In addition, the controller 70 may control the air supplier so as to keep constant the amount of fluid supplied to the dryer chamber 10 through the supply duct 21 and the amount of fluid discharged from the dryer chamber 10 through the exhaust duct 22.

In controlling the temperature of the dryer chamber 10 according to an embodiment, the controller 70 may adjust the supply amount of the heat transfer medium and adjust the opening or closing of the bypass damper 24, but the supply amount of the fluid supplied to the supply duct 21 may be kept constant.

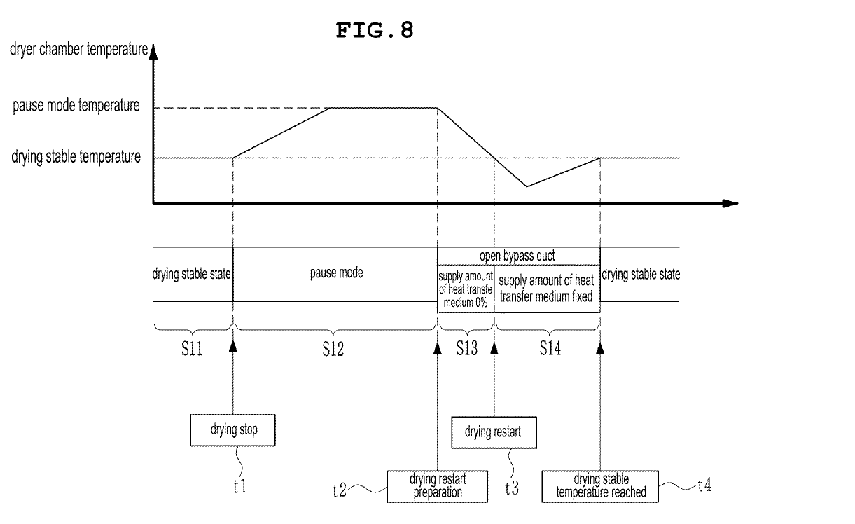

FIG. 7 is a flowchart showing an electrode drying method according to an embodiment. FIG. 8 is a view showing the temperature change in the dryer chamber 10 according to an embodiment. Referring to FIGS. 2, 7 and 8, temperature control of the dryer chamber 10 according to an embodiment will be described.

An electrode drying method according to an embodiment relates to a method for adjusting the temperature of the dryer chamber 10 in the case where the electrode 2 is temporarily stopped from entering the dryer chamber 10 and enters the dryer chamber 10 again after a certain period of time has elapsed.

The electrode drying method may include: a bypass duct opening step (S120) of controlling the bypass damper 24 connected to the bypass duct 23 so that the bypass duct 23 connecting the supply duct 21 and the exhaust duct 22 of the dryer chamber 10 is opened before the electrode 2 re-enters the dryer chamber 10; a first supply amount control step (S130) of controlling the heat transfer medium supplier 50 so that the supply amount of heat transfer medium supplied to the heater 40 that heats the fluid in the supply duct 21 becomes a first set amount before the electrode 2 re-enters the dryer chamber 10; and a second supply amount control step (S140) of controlling the heat transfer medium supplier 50 to fix the supply amount of the heat transfer medium supplied to the heater 40 to a reference supply amount at the point when the electrode 2 re-enters the dryer chamber 10.

The electrode drying method may further include: a bypass duct closing step (S150) of controlling the bypass damper 24 so that the bypass duct 23 is closed when the temperature of the dryer chamber 10 reaches the drying stable temperature; and a third supply amount control step (S160) of controlling the heat transfer medium supplier 50 by using feedback control to control the supply amount of the heat transfer medium supplied to the heater 40 on the basis of the temperature of the exhaust duct 22 when the temperature of the dryer chamber 10 reaches the drying stable temperature.

In addition, the electrode drying method according to an embodiment may further include a pause mode step (S110), prior to the bypass duct opening step (S120), of performing a pause mode for maintaining the internal temperature of the dryer chamber 10 at a set temperature when the electrode 2 stops entering the dryer chamber 10.

First, it is possible to enter a state in which continuous drying of the electrode 2 is temporarily stopped (S12 of FIG. 2 and FIG. 8) from a drying stable state (S11 of FIG. 2 and FIG. 8) in which the electrode 2 continuously enters the dryer chamber 10 and drying is performed. The point in time at which the drying stable state ends may be referred to as a drying stop point t1.

When the drying stop point t1 is reached, the controller 70 may perform the pause mode step (S110). The section in which the pause mode is maintained may be from the drying stop point t1 to a drying restart preparation point t2. The section in which the pause mode is maintained may correspond to a state in which continuous drying of the electrode 2 is temporarily stopped (S12 of FIG. 2 and FIG. 8).

In the pause mode step (S110), the controller 70 may control the heat transfer medium supplier 50 so that the temperature of the dryer chamber 10 does not excessively increase or decrease. In the pause mode, the temperature of the dryer chamber 10 may be maintained at a set temperature. The set temperature may be referred to as the pause mode temperature. In this case, the set temperature may be such that the temperature of the exhaust duct 22 is maintained higher than the temperature of the exhaust duct 22 in the drying stable state, and the temperature of the supply duct 21 is maintained lower than the temperature of the supply duct 21 in the drying stable state. Therefore, the pause mode may be considered a mode in which the temperature of the exhaust duct 22 is maintained higher than the temperature of the exhaust duct 22 in the drying stable state, and the temperature of the supply duct 21 is maintained lower than the temperature of the supply duct 21 in the drying stable state.

In the pause mode, the controller 70 may control the heat transfer medium supplier 50 to maintain the temperature of the dryer chamber 10 at the pause mode temperature using feedback control.

When the controller 70 performs the pause mode to maintain the temperature of the dryer chamber 10 at set value, the problem of the electrode 2 being overdried due to an excessive increase in the temperature of the dryer chamber 10 may be prevented, the temperature of the dryer chamber 10 may quickly converge to the drying stable temperature after drying is restarted, and hunting may be prevented when the temperature of the dryer chamber 10 converges toward the drying stable temperature. Hunting refers to the process of reaching the drying stable temperature by alternating between higher and lower temperatures than a reference temperature. If hunting occurs, the time required to reach the drying stable temperature becomes longer and the drying quality may become uneven.

The point in time at which the electrode 2 re-enters the dryer chamber 10 may be referred to as a drying restart point t3. Prior to the drying restart point t3, the controller 70 may perform the bypass duct opening step (S120) to control the bypass damper 24 connected to the bypass duct 23 to open so that the bypass duct 23 is opened. The time point at which the bypass duct 23 is opened may be referred to as the drying restart preparation point t2. When the bypass duct 23 is opened, at least a portion of the fluid supplied to the dryer chamber 10 from the supply duct 21 may be discharged through the exhaust duct 22 along the bypass duct 23, so that the temperature of the dryer chamber 10 may be lowered.

Prior to the drying restart point t3, the controller 70 may perform the first supply amount control step (S130) that controls the heat transfer medium supplier 50 so that the supply amount of the heat transfer medium supplied to the heater 40 becomes the first set amount. To be specific, the supply amount of the heat transfer medium may be controlled to be the first set amount at the drying restart preparation point t2. The purpose is to control the heat transfer medium not to supply heat to the heater 40 in order to lower the temperature of the dryer chamber 10 before the drying restart point t3. If the heater 40 is not supplied with the heat transfer medium, the temperature of the fluid passing through the heater 40 gradually decreases, and the temperature of the fluid supplied to the dryer chamber 10 also decreases. When the controller 70 controls the heat transfer medium supplier 50 so that the amount of heat transfer medium supplied to the heater 40 becomes the first set amount, the control of the heat transfer medium supplier 50 through feedback control used in the pause mode is stopped.

The bypass duct opening step (S120) and the first supply amount control step (S130) may be performed simultaneously. That is, at the drying restart point t3, the bypass duct opening step (S120) and the first supply amount control step (S130) may be performed simultaneously. The section where the bypass duct opening step (S120) and the first supply amount control step (S130) are performed simultaneously may correspond to the step (S13 of FIG. 2 and FIG. 8) where the electrode 2 is transferred to the dryer chamber 10 to re-enter the dryer chamber 10. The section corresponds to a section for lowering the temperature of the dryer chamber 10 before the electrode 2 enters the dryer chamber 10. When the bypass duct opening step (S120) and the first supply amount control step (S130) are performed simultaneously, the amount of fluid supplied to the dryer chamber 10 decreases and the temperature decreases, so the temperature of the dryer chamber 10 may be lowered quickly.

The drying restart preparation point t2 at which the bypass damper 24 is opened and the supply amount of the heat transfer medium is controlled to zero prior to the drying restart point may be determined by considering the moving speed of the electrode 2, the temperature of the dryer chamber 10, the supply amount of the fluid, etc.

When the drying restart point t3 arrives, the controller 70 may perform the second supply amount control step (S140) to control the heat transfer medium supplier 50 to fix the supply amount of the heat transfer medium to the reference supply amount. At this time, the bypass duct 23 may be kept open. The reference supply amount of the second supply amount control step (S140) may be the supply amount of the heat transfer medium supplied to the heater 40 in the drying stable state. Since the temperature of the dryer chamber 10 decreases while the supply of the heat transfer medium is controlled to zero in the first supply amount control step (S130) and the bypass damper 24 is kept open, the controller 70 may control the temperature of the dryer chamber 10 to rise again to reach the drying stable temperature when the drying restart point arrives.

In this case, if the controller 70 does not fix the supply amount of the heat transfer medium to the set value and applies feedback control, even if the supply amount of the heat transfer medium is increased to reach the drying stable temperature, the temperature of the dryer chamber 10 may not rise sufficiently because the bypass path is open. In addition, as described with reference to FIG. 5, the amount of heat transfer medium supplied increases further, and when the bypass damper 24 is closed, excessively high temperature fluid is supplied to the dryer chamber 10, causing the temperature of the dryer chamber 10 to overshoot and hunting to occur.

According to an embodiment, in the second supply amount control step (S140), the controller 70 fixes the supply amount of the heat transfer medium to the reference supply amount at the drying restart point t3, so that the temperature of the dryer chamber 10 gradually increases. Since the amount of heat transfer medium supplied is determined regardless of the temperature of the dryer chamber 10, the temperature of the fluid supplied to the dryer chamber 10 through the supply duct 21 may gradually increase. The section where the bypass duct 23 is opened and the supply amount of the heat transfer medium is maintained at the reference supply amount may correspond to the step (S14 of FIG. 2 and FIG. 8) where the electrode 2 re-enters the dryer chamber 10 and part of the electrode 2 begins to dry.

Next, when the temperature of the dryer chamber 10 reaches t4 the drying stable temperature, the controller 70 may perform the bypass duct closing step (S150) of controlling the bypass damper 24 to close the bypass duct 23. In addition, when the temperature of the dryer chamber 10 reaches t4 the drying stable temperature, the controller 70 may perform the third supply amount control step (S160) of controlling the heat transfer medium supplier 50 to apply feedback control to the supply amount of the heat transfer medium.

Once the temperature of the dryer chamber 10 reaches the drying stable temperature, even if the bypass damper 24 is closed so that all the fluid in the supply duct 21 is supplied to the dryer chamber 10, there is no risk of hunting in the temperature of the dryer chamber 10. When the temperature of the dryer chamber 10 reaches the drying stable temperature, adjusting the supply of the heat transfer medium using feedback control may effectively maintain the drying stable temperature. In addition, even if a change to feedback control is made, temperature hunting may not occur because the temperature of the dryer chamber 10 has already reached the drying stable temperature.

While performing an electrode drying method according to an embodiment, the amount of fluid supplied to the dryer chamber 10 through the supply duct 21 and the amount of fluid discharged from the dryer chamber 10 through the exhaust duct 22 may be kept constant.

Above, the present disclosure has been described in detail through specific embodiments. The above description is merely an example of applying the principles of the present disclosure, and other configurations may be further included without departing from the scope of the present disclosure.

What is claimed is:

1. An electrode drying method for regulating temperature of a dryer chamber when an electrode is temporarily stopped from entering the dryer chamber and the electrode re-enters the dryer chamber after a certain period of time has elapsed, the method comprising:
a bypass duct opening step of controlling a bypass damper connected to a bypass duct so that the bypass duct connecting a supply duct and an exhaust duct of the dryer chamber is opened before the electrode re-enters the dryer chamber;
a first supply amount control step of controlling a heat transfer medium supplier so that an amount of a heat transfer medium supplied to a heater that heats a fluid in the supply duct becomes a first set amount before the electrode re-enters the dryer chamber; and
a second supply amount control step of controlling the heat transfer medium supplier to fix the amount of the heat transfer medium supplied to the heater to a reference supply amount at a point when the electrode re-enters the dryer chamber.

2. The method of claim 1, further comprising:
a bypass duct closing step of controlling the bypass damper so that the bypass duct is closed when the temperature of the dryer chamber reaches a drying stable temperature; and
a third supply amount control step of controlling the heat transfer medium supplier by using feedback control to control the amount of the heat transfer medium supplied to the heater on a basis of temperature of the exhaust duct when the temperature of the dryer chamber reaches the drying stable temperature.

3. The method of claim 1, further comprising:
a pause mode step, prior to the bypass duct opening step, of performing a pause mode for maintaining an internal temperature of the dryer chamber at a set temperature when the electrode stops entering the dryer chamber.

4. The method of claim 3, wherein the pause mode is a mode in which temperature of the exhaust duct is maintained higher than the temperature of the exhaust duct in a drying stable state, and temperature of the supply duct is maintained lower than the temperature of the supply duct in the drying stable state.

5. The method of claim 1, wherein the bypass duct opening step and the first supply amount control step are performed simultaneously.

6. The method of claim 1, wherein the reference supply amount of the second supply amount control step is an amount of the heat transfer medium supplied to the heater in a drying stable state.

7. The method of claim 1, wherein an amount of a fluid supplied to the dryer chamber through the supply duct and an amount of a fluid discharged from the dryer chamber through the exhaust duct are kept constant.

8. An electrode drying apparatus, comprising:
a dryer chamber through which an electrode passes and is dried;
a supply duct configured to supply a fluid to the dryer chamber;
an exhaust duct configured to discharge a fluid from the dryer chamber;
a bypass duct configured to connect the supply duct and the exhaust duct;
a bypass damper configured to operate to open or close the bypass duct;
a heater configured to heat the fluid supplied to the dryer chamber through the supply duct;
a heat transfer medium supplier configured to supply a heat transfer medium to the heater; and
a controller configured to control the bypass damper and the heat transfer medium supplier,
wherein the controller: controls, before the electrode re-enters the dryer chamber in a case where the electrode is temporarily stopped from entering the dryer chamber and enters the dryer chamber again after a certain period of time has elapsed, the bypass damper connected to the bypass duct so that the bypass duct connecting the supply duct and the exhaust duct of the dryer chamber is opened; controls the heat transfer medium supplier so that an amount of the heat transfer medium supplied to the heater that heats the fluid in the supply duct becomes a first set amount; and controls, at a point when the electrode re-enters the dryer chamber, the heat transfer medium supplier to fix the amount of the heat transfer medium supplied to the heater to a reference supply amount.

9. The apparatus of claim 8, further comprising:
a first temperature sensor connected to the supply duct to measure temperature of the fluid supplied from the supply duct to the dryer chamber; and
a second temperature sensor connected to the exhaust duct to measure temperature of the fluid discharged from the dryer chamber to the exhaust duct,
wherein the controller controls, when temperature of the dryer chamber reaches a drying stable temperature on a basis of measurement values of the first temperature sensor and the second temperature sensor, the bypass damper so that the bypass duct is closed, and controls the heat transfer medium supplier by using feedback control that controls the amount of the heat transfer medium supplied to the heater on a basis of temperature of the exhaust duct.

10. The apparatus of claim 9, wherein the controller further performs a pause mode to maintain an internal temperature of the dryer chamber at a set temperature until the bypass duct is opened when the electrode stops entering the dryer chamber.

11. The apparatus of claim 10, wherein the pause mode is a mode in which temperature of the exhaust duct is maintained higher than the temperature of the exhaust duct in a drying stable state, and temperature of the supply duct is maintained lower than the temperature of the supply duct in the drying stable state.

12. The apparatus of claim 8, wherein the controller simultaneously performs an operation of controlling the bypass damper connected to the bypass duct so that the bypass duct connecting the supply duct and the exhaust duct of the dryer chamber is opened, and an operation of controlling the heat transfer medium supplier so that the amount of heat transfer medium supplied to the heater that heats the fluid in the supply duct becomes the first set amount.

13. The apparatus of claim 8, wherein the reference supply amount is an amount of the heat transfer medium supplied to the heater in a drying stable state.

14. The apparatus of claim 8, further comprising:
an air supplier configured to supply a fluid through the supply duct,
wherein the controller controls the air supplier to keep an amount of the fluid supplied to the dryer chamber through the supply duct and an amount of the fluid discharged from the dryer chamber through the exhaust duct constant.
